(19) United States
(12) Patent Application Publication
(10) Pub. No.: US 2002/0172868 A1
(43) Pub. Date: Nov. 21, 2002

(54) Cathode with performance enhancing additive

(76) Inventors: Michael Manna, Farmington, NY (US); Edward Cuellar, Canandaigua, NY (US)

Correspondence Address: ISRAEL NISSENBAUM, 1038-56TH ST, BROOKLYN, NY, 11219, US

(21) Appl. No.: 10/099,288

(22) Filed: Mar. 14, 2002

Related U.S. Application Data
(60) Provisional application No. 60/275,812, filed on Mar. 14, 2001.

(51) Int. Cl. H01M 4/62; H01M 4/50; H01M 4/52

(52) U.S. Cl. 429/232; 429/231.1; 429/224; 429/223; 429/231.3

(57) ABSTRACT

Performance of electrochemical cells is improved and construction is facilitated with the addition of from about 0.25% to 3% by weight of silica (fumed or non-fumed) and the like, particularly fumed silica, to the cathodes of the cells and particularly to cathodes comprised of lithiated metal oxide.

### FIELD OF THE INVENTION

This invention relates to rechargeable, high energy density electrochemical cells and particularly to the cathodes of such cells and most particularly to cathodes comprised of lithiated metal oxides, with facilitated construction and enhanced performance characteristics.

### BACKGROUND OF THE INVENTION

Currently, high energy density rechargeable cells are commonly utilized for state of the art applications such as cell phones, lap-top computers, and the like. However, despite the enhanced capability of such cells there are still constantly increasing demands, particularly for discharge longevity, recyclability, and rate capability. In addition, because of the numerous components and handling requirements, facilitated handling and construction of cell components is highly economically and technically desirable.

Common high energy density rechargeable cells typically have anodes with formulations comprised of about 75 to 90% graphite, binder polymers, porosity forming plasticizers and additional conductive fillers. Typical cathode formulations are similar, containing materials such as lithiated metal oxide (about 70 to 90%) with the remainder being binding polymers, porosity forming plasticizers and conductive fillers. Electrolytes in such cells are non-aqueous organic binary or ternary systems such as of ethylene carbonate (EC) and dimethyl carbonate with a lithium salt such as lithium hexafluorophosphate.

### SUMMARY OF THE INVENTION

It is an object of the present invention to provide an improved cathode for electrochemical cells and particularly improved lithiated metal oxide cathodes for rechargeable non-aqueous cells, by providing them with electrode enhancement materials to facilitate cathode construction and to provide enhanced rechargeability, consistent high rate capability and discharge characteristics.

It is a further object of the present invention to provide a cathode material which simplifies cast or coated film cathode structure construction and results in enhanced discharge characteristics.

Generally the present invention comprises an electrochemical cell with a cathode comprising an active depolarizer material and electrode enhancing means to both facilitate construction of cathode layers, laminates or film structures thereof (with or without supporting substrates) and to increase current and discharge capability of the cathode. The enhancing means comprises an additive in the cathode formulation, which enhances physical properties of a cast, coated, extruded or similarly prepared film cathode. The enhancing means favorably affects physical stability of the cathodes as discrete members with or without supporting substrates. As a result, electrochemical properties are concomitantly enhanced.

The preferred additive is fumed silica. Other potential additives that can be used in substitution of silica include alumina, non-fumed silica, chemically treated silica, and similar materials. The physical enhancements provided by the silica or alumina additives over cathodes constructed without such additives include measurably increased cohesiveness for maintaining integrity of the cathode structure over repeated cycling. Elongation properties are also enhanced thereby minimizing loss of capacity from isolated disconnected segments of the cathode. Current collector adhesion is improved with reduction of internal resistance. Separator to electrode adhesion is improved thereby further reducing current loss from internal resistance. In addition, overall strength of the cathodes and the cells is improved. The physical structure of the cathodes is enhanced, with the uniformity of adhesion of components. As a further result, processing of stronger cell components and cells is simplified and production rejects are significantly decreased.

Electrochemical enhancements resulting from the physical improvements provided by the additives of the present invention include increased electrolyte wetting and distribution, with increased rate capability, enhanced temperature storage performance, improved impedance and impedance growth performance.

The addition of the additive materials of the present invention to the cathodes of electrochemical cells enhances physical properties of the cast, coated, extruded or similarly prepared film which constitutes the cathodes thereof. These generally flat or rolled structures particularly benefit from the physical enhancements resulting from the addition of the alumina and/or silica additives and particularly the addition of fumed silica additives.

Other objects, features and advantages of the present invention will become more evident from the following discussion.

### DETAILED DESCRIPTION OF THE INVENTION

The additive of the present invention, such as the various silicas or alumina, is preferably added to a cathode formulation with metal oxide active material such as LiNiO₂, LiMn₂O₄, LiCO0₂, LiₓNiCo_{1-x-y}Al_{y}O₂ or similar material. The active material is typically contained in a polymer matrix such as a copolymer PVFD-HFP, or terpolymer VDF-HFP-TFE, or the like. A conductive filler is normally used as an additive in the formulation to enhance electrical conductivity and reduce impedance. Conductive materials of this type include MMM Super P carbon black. A plasticizer such as DBP or PC is usually, but not necessarily added to the formulation. The active cathode material content (weight basis) of the formulation commonly ranges from 70 to 95%, with polymer content ranging from 1 to 12%, plasticizer ranging from 0 to 12%, and the conductive filler ranging from about 0 to 10%.

The enhancement additive material of the present invention is added to the formulation of the cathode in a range of about 0.1 to 5% of the total formulation weight or as a fraction weight of one of the other components.

Examples of types of silica useful in the present invention include those silicas with the common formula SiO₂. Treated fumed silicas include Dimethyl-dichloro-silane (DDS), Hexamethyl-disilazone (HMDS), trimethoxy-octyl-silane, Octamethyl-cyclo-tetra-siloxane, Hexadeccylsilane, Methyacryl-silane. A particularly preferred silica is the HMDS type available from suppliers Cabosil, PPG, Sivento/Degussa-Hula.

Typical anode formulations are comprised of 75 to 90% graphite, such as Osaka Gas MCMB 10-28; 5 to 15% polymer, such as Elf Atochem Kynar 2801 PVDF-HFP; 1 to 10% plasticizer such as dibutyl phthalate, and 0.5% to 5% of conductive filler such as MMM super-p carbon.

Common cathode formulations are comprised of 70 to 90% lithiated metal oxide such as Siedo LiCO₂, 5 to 15% polymer such as Elf Atochem Kynar 2801 PVDF-BFP, 1 to 10% plasticizer such as dibutyl phthalate, and 0.5% to 5% of conductive filler such as MMM super-p carbon. The addition of a silica compound in the range of 0.25 to 3% increases electrode wetability. Structural integrity enhancement is particularly useful in rechargeable cells in which lithium ions are inserted and removed during cycling, with concomitant expansion and contraction of the electrodes.

Anode and cathode films may be manufactured using a solvent cast system using a doctor blade apparatus as disclosed in U.S. Pat. No. 5,460,904, by coating on release substrate, or coating the material directly to the current collector (expanded or solid foils). The separator may be manufactured as disclosed in said patent, or by utilizing a discrete separator element such as disclosed in U.S. Pat. No. 5,962,162.

In an embodiment of the present invention, the anode and cathode films are heat laminated under pressure to current collectors in the temperature range of 120 to 170° C. to form anode and cathode electrodes. The electrodes are heat treated under pressure to the separator material to form a lithium polymer cell. The cell may be assembled as a common single plate structure, with a central cathode and central anode or in a common wound or “jelly-roll” configuration. Multiple unit assemblies may be assembled in parallel or serial configuration depending on the voltages and discharge capabilities required.

The components of the individual cells are extracted in methanol to remove the plasticizer and the cells are packaged using a laminated foil packaging material to accommodate electrode expansion and any slight gassing. Electrolytes such as the common rechargeable cell solvent EC-DMC in a 1-1 volumetric ratio and with 1M LiPF₆ electrolyte salt provides the non-aqueous electrolyte for a lithium polymer or lithium ion cell.

In order to demonstrate the efficacy of the present invention, a series of identical cells were constructed with and without the additive of the present invention with details and test results set forth in the following examples.

### EXAMPLES 1-12

### Prior Art

Twelve identical cells were constructed with graphite anodes and cathodes comprised of 86% active LiCoO₂ cathode materials, 6% plasticizer (DBP) and 1% conductive filler (SP). Cell capacities were each nominally 1500 mAhr each. The cells were discharged and the following TABLE I summarizes the results of such discharge tests.

TABLE I
Non-Enhanced formulation (86% Active (LiCoO2), 7% Polymer,
6% plasticiser (DBP), 1% Conductive Filler (SP))

| All Data in mAhrs (Group F2242) | | | | | |
|---|---|---|---|---|---|
| C = 1500 mahr | | | Total Signature | | |
| | C-rate | 2C rate | Curve to C/5 | % C Rate | |
| Cell | Capacity | Capacity | Capacity | Cap/Tot Sig | % 2C Rate Cap/Tot Sig |
| 12 | 1005.68 | 176.43 | 1322.06 | 76% | 13% |
| 13 | 1049.84 | 239.82 | 1255.70 | 84% | 19% |
| 14 | 452.68 | 276.96 | 1147.75 | 39% | 24% |
| 15 | 992.60 | 137.13 | 1290.41 | 77% | 11% |
| 16 | 923.06 | 103.00 | 1278.46 | 72% | 8% |
| 17 | 951.00 | 159.00 | 1238.03 | 77% | 13% |
| 18 | 533.73 | 107.07 | 1176.03 | 45% | 9% |
| 19 | 1008.57 | 201.48 | 1203.51 | 84% | 17% |
| 20 | 873.18 | 139.66 | 1211.63 | 72% | 12% |
| 21 | 841.01 | 218.04 | 1261.26 | 67% | 17% |
| 22 | 582.38 | 111.53 | 1201.70 | 48% | 9% |
| 24 | 460.95 | 150.85 | 1122.44 | 41% | 13% |

### EXAMPLES 13-29

Seventeen cells were made as in Examples 1-12 but on a smaller scale with each having a nominal capacity of 75 mAhr and with the additive of the present invention included in each of the cathodes. The cathodes were comprised of 85.27% active LiCoO₂ cathode material, 6.94% polymer, 5.94% DBP plasticizer, 0.99% conductive filler (SP) and 0.85% fumed silica additive. The cells were discharged as in Examples 1-12 with the following TABLE II setting forth the results of said tests.

TABLE II
Enhanced Formulation (85.27% Active (LiCoO2), 6.94% Polymer,
5.95% plasticiser (DBP), 0.99%
Conductive Filler (SP), 0.85% Enhancement (fumed silica))

| All Data in mAhrs (Group F3446) | | | | | |
|---|---|---|---|---|---|
| C = 75 mahr | | | Total Signature | | |
| | C-rate | 2C rate | Curve to C/5 | % C Rate | |
| Cell | Capacity | Capacity | Capacity | Cap/Tot Sig | % 2C Rate Cap/Tot Sig |
| 101 | 65.86914 | 46.92161 | 70.68547 | 93% | 66% |
| 102 | 68.67343 | 55.63013 | 73.78912 | 93% | 75% |
| 103 | 69.50008 | 54.48522 | 74.56882 | 93% | 73% |
| 104 | 69.65173 | 54.5298 | 74.59919 | 93% | 73% |
| 105 | 68.34344 | 53.68733 | 73.3071 | 93% | 73% |
| 106 | 69.0732 | 56.52686 | 74.38147 | 93% | 76% |
| 107 | 69.02677 | 54.19974 | 74.15433 | 93% | 73% |
| 108 | 69.24654 | 54.36482 | 74.38623 | 93% | 73% |
| 109 | 70.86649 | 55.50813 | 76.52397 | 93% | 73% |
| 110 | 69.39736 | 54.75649 | 74.37743 | 93% | 74% |
| 111 | 69.51301 | 52.11647 | 75.13641 | 93% | 69% |
| 112 | 69.44611 | 53.40436 | 74.61346 | 93% | 72% |
| 113 | 68.84073 | 50.29324 | 74.26093 | 93% | 68% |
| 114 | 69.29071 | 50.14243 | 74.5593 | 93% | 67% |
| 115 | 68.79092 | 48.39413 | 73.88792 | 93% | 65% |
| 116 | 67.63014 | 45.84302 | 72.41983 | 93% | 63% |
| 117 | 64.12365 | 41.5819 | 69.19793 | 93% | 60% |

In the above tables, the C-rate capacity is the discharge capacity obtained at ambient constant current discharge at the current equal to the design capacity of the cell. The C Rate is the current that should remove 100% of the specific capacity based upon cathode active content in one hour.

The 2C rate capacity is the ambient constant current discharge at 2 times the C rate capacity (the current rate that will move 100% of the capacity in 0.5 hours).

The total signature curve capacity to C/5 is the cumulative capacity of a 2C discharge, 15 minutes of rest, C rate discharge, then 15 minutes of rest, C/2 rate discharge, 15 minutes rest, and C/5 rate discharge. This closely approximates the capacity removed at the C/5 rate, which is a five hour discharge.

%C rate capacity/total signature is the percentage of low rate discharge capacity achieved at the C rate. %2C rate capacity/total signature is the percentage of low rate discharge capacity achieved at the 2C rate. It is the %C rate capacity/total signature and %2C rate capacity/total signature which are indicative of effective cell performance particularly of rechargeable cells. When high rate is normalized to the low rate discharge capacity cells of differing capacities can be validly compared directly to each other.

In Table I, for the prior art cells without fumed silica in the cathode, %C rate capacity/total signature and %2C rate capacity/total signature varied widely and were relatively low. The results in Table II showing percentage rates of %C and %2C were almost totally consistent and significantly higher than those shown in Table I for the prior art cells.

It is understood that the above examples and specifics of cell construction, components and the like are merely exemplary of the present invention and that changes may be made without departing from the scope of the present invention as defined in the following claims.

What is claimed is:

1. An electrochemical cell comprising an anode, a cathode and an electrolyte wherein said cathode comprises an active depolarizer material admixed with an additive comprised of a member of the group consisting of alumina, fumed silica, non-fumed silica, chemically treated silica and mixtures thereof.

2. The electrochemical cell of claim 1, wherein the cathode comprises any one of one or more layer, laminates or film structures, whereby the additive is present in an amount sufficient to enhance stability of the cathode as a discrete member.

3. The electrochemical cell of claim 2, wherein said additive is comprised of fumed silica.

4. The electrochemical cell of claim 3, wherein said cathode is comprised of film wherein said film is cast, coated, or extruded.

5. The electrochemical cell of claim 3, wherein said cathode is a metal oxide active material.

6. The electrochemical cell of claim 5, wherein said metal oxide is selected from the group consisting of LiNiO₂, LiMn₂O₄, LiCO0₂, and LiₓNiCo_{1-x-y}Al_{y}O₂.

7. The electrochemical cell of claim 3, wherein the additive material comprises about 0.1 to 5% of the total formulation weight of the cathode

8. The electrochemical cell of claim 3, wherein the fumed silica is treated with one of Dimethyl-dichloro-silane (DDS), Hexamethyl-disilazone (HMDS), trimethoxy-octyl-silane, Octamethyl-cyclo-tetra-siloxane, Hexadeccylsilane, Methyacryl-silane.

9. The electrochemical cell of claim 6, wherein the anode is comprised of 75 to 90%, by weight, of graphite, 5 to 15% by weight of polymer, 1 to 10% by weight of plasticizer and 0.5% to 5% of conductive filler.

10. The electrochemical cell of claim 3, wherein the silica compound is present in the range of 0.25 to 3%.
